(19) United States
(12) Patent Application Publication
(10) Pub. No.: US 2009/0021956 A1
(43) Pub. Date: Jan. 22, 2009

(54) Illuminated Tray for Containers

(76) Inventors: Andries Willem Grobler, Raleigh, NC (US); Leon C. Keynhane, Raleigh, NC (US)

Correspondence Address: THE PARKER LAW OFFICE, PLLC, 800 COUNTRY CLUB DRIVE, PO BOX 8334, ROCKY MOUNT, NC, 27804-1334, US

(21) Appl. No.: 11/778,363

(22) Filed: Jul. 16, 2007

(51) Int. Cl. F21V 8/00; F21V 33/00

(52) U.S. Cl. 362/554; 362/154; 362/551

(57) ABSTRACT

An illuminated display tray comprising a base, an outer perimeter defining a top and bottom, at least one cavity adapted to receive at least one lighting means, a power means mounted in a recess formed in the bottom and operably connected to the lighting means, a switch mounted on the top and operably connected to the lighting means and power means, and a container having a base in association with the top, the lighting means adapted to direct light up and through the top and the associated container.

### BACKGROUND OF THE INVENTION

1. Field of the Invention

The present invention relates generally to an illuminated tray, specifically to an illuminated tray for displaying and illuminating containers placed on the tray top.

2. Description of the Related Art

Display trays are utilized to hold a variety of objects for temporary storage and display in homes and businesses. In homes, people often use trays to hold trinkets, statuettes, figurines, bottles, or containers. In businesses, trays are sometimes used to display products for sale. These displays attempt to provide stimulating visual appeal to shoppers, enticing them to make a purchase. Trays tend to be easy to move, and may be styled in an aesthetically pleasing manner.

A common use includes serving trays. Restaurants and other eating and drinking establishments use serving trays to bring food and beverages to and from customers. Some of these trays include lights or other means of illuminating the tray to provide visual or safety stimulation. Others have proposed insertion of penlight style flashlights into trays for illumination, strings of LED's positioned in the tray rim, and the use of light transmission plates to disperse light in the tray. Other devices for holding individual glasses or bottles include coasters having LED's or lights positioned therein, or specialized bases adapted to receive mating containers wherein the light shines up through the container. These devices typically include restaurant serving trays and beverage coasters.

Trays used in homes, such as those to hold perfumes or jewelry, lack an effective lighting means to display items placed on the tray. In low light situations, someone would have difficulty locating the appropriate items placed on the tray. By way of example, if the tray holds multiple containers of perfume or cologne, a person might mistakenly use the wrong container. To properly see the items placed on the tray, the person would need to turn on other lighting systems in the room.

### BRIEF SUMMARY OF THE INVENTION

In a first aspect, the present invention comprises an illuminated tray that associates with containers placed thereon, providing a visually striking display to facilitate location of items placed thereon or associated with the tray. Such illuminating characteristics also facilitate sales of the device, containers, and product contained therein when used as a sale display.

In another aspect, the invention comprises an illuminated tray that may be manufactured from a variety of materials providing flexibility in manufacturing while allowing multiple product price points for the device.

In yet another aspect, the invention comprises a translucent illuminated tray that operates as a night-light for use in dark rooms allowing a user to easily identify objects placed on the tray.

In yet another aspect, the invention comprises an illuminated tray providing enhanced visual appeal through the use of a fiber optic element, providing an aesthetically pleasing appearance in a tray manufactured wholly from translucent material.

### BRIEF DESCRIPTION OF THE DRAWINGS

FIG. 1 shows a plan view of the top of a Display Tray for Containers in which the present invention is practiced.

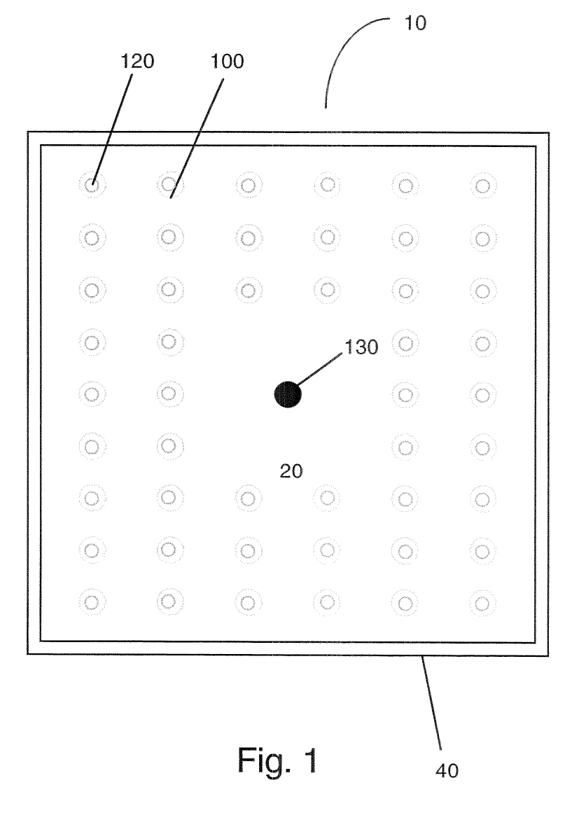

FIG. 2 shows a plan view of the bottom of a display tray in which the present invention is practiced.

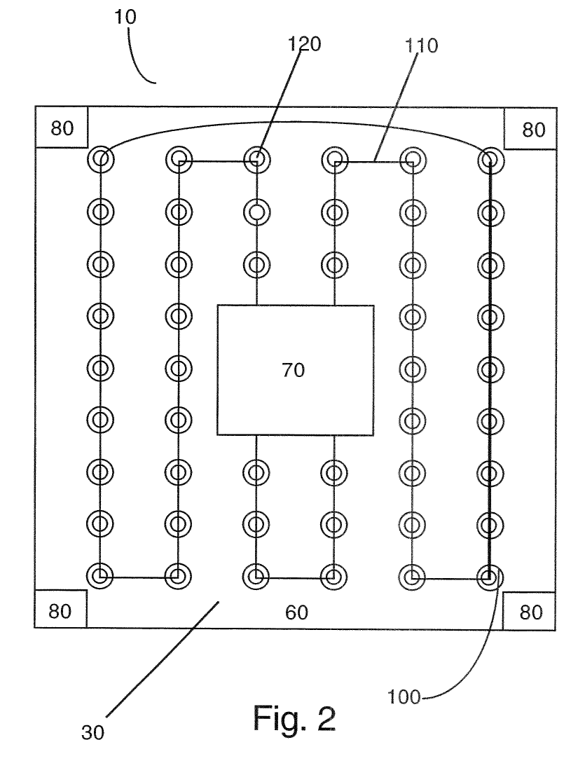

FIG. 3 shows a cross section view of the display tray in which the present invention is practiced with a container.

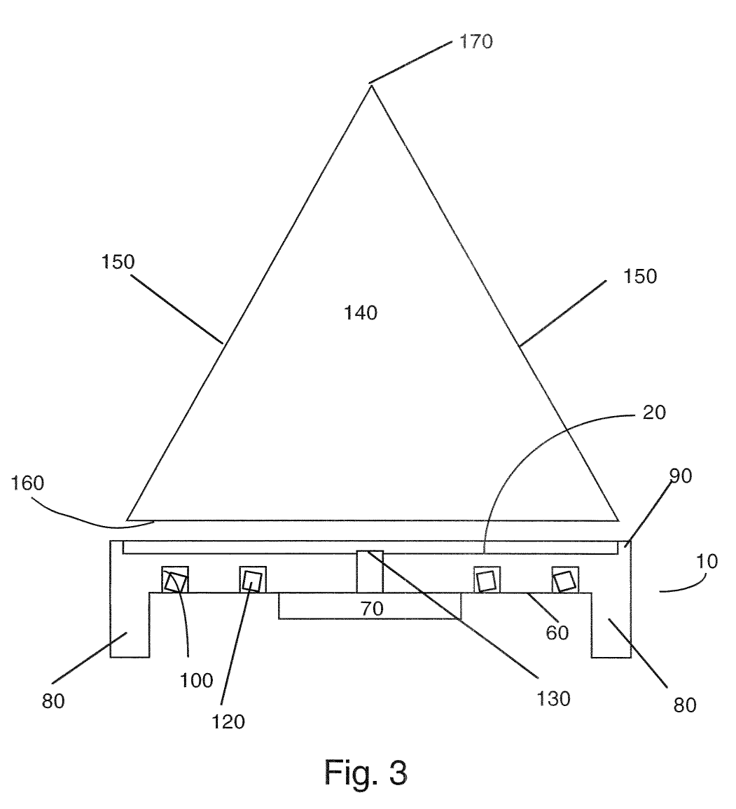

### DETAILED DECSRIPTION OF THE INVENTION

Referring now to the drawings, a tray 10 for displaying containers 140 is shown. The tray 10 comprises a base 60 having an outer perimeter 40 defining a top 20 and a bottom 30. One or more supports 80 are formed into the base 60, elevating the bottom. A flange 90 preferably extends above the top 20 along the outer perimeter 40. The flange 90 is adapted to secure containers and other items placed on the top 20 of the tray 10 from lateral movement. The tray 10 is preferably formed from a unitary piece of translucent material. Depending on the desired tray 10 price point, the tray 10 could be manufactured from plastic, resin, glass, fine crystal, or other similar materials. Additionally, the tray 10 may include various adornments or decorative figures formed therein or attached thereto for further aesthetic appeal. For further utility, the tray 10 may be adapted to accommodate and retain a plurality of containers 140.

The tray 10 has a lighting means 50 which preferably mounts inside at least one sleeve or cavity means 100 formed within the tray 10. A power source 70 operably connected to the lighting means 50 provides power to illuminate the lighting means 50. The lighting means 50 depicted in the drawings is comprised of an array of light emitting diodes (LED's 120) operably connected by a connection means such as a wire 110. However, the lighting means should comprise at least one LED 120. In alternate embodiments the LED's 120 may be mounted to and operably connected by a wafer board or substrate board. Each LED 120 mounts in a cavity means 100 recessed into the bottom 60 to direct light upwardly through the top 20, illuminating the top 20 and any items placed thereon. Each cavity means is adapted to receive an individual one of the LED's 120. Additionally, a translucent container 140 for holding liquids is further provided for use with the tray 10. When the container 140 is in association with the try 10 top 20, each LED 120 directs light upwardly through the container 140, illuminating the container 140 and its contents. Preferably, at least one LED 120 is mounted in a position to direct light upwardly through the container 140 wall. The preferred container 140 is pyramidally shaped, having triangular walls 150 and a square base 160 and an apex 170. In this configuration, the LED 120 illuminating the container 140 wall may direct light between a range of vertical or at an angle from vertical to provide a desired lighting effect. By way of example, the LED's 120 can be positioned to direct light at an angle and upwardly through the outer perimeter of the container base 160, the walls 150, and towards the apex 170, providing a striking display and useful illumination. When illuminated, the tray 10 and container 140 placed thereon provide a striking visual display that is useful as a night-light. Illumination from the lighting means 50 through the tray 10 and container 140 make finding and selecting the container 140 easy in low lighting situations. Ideally, the container 140 holds fragrances, perfumes, colognes, or other similar products, although the container's 140 use is not limited to such. Additionally, the illuminated tray 10 and container 140 may be used as a display to facilitate in-store sales of the tray 10 and containers 140. Illumination enhances the tray 10 and container's 140 appearance, drawing customers to the display and providing an incentive to purchase the tray 10, container 140 and its contents, or both. Illumination also provides aesthetic appeal and useful light to consumers for home use.

Each LED 120 operably connects with a power source 70. The power source 70 may either be a battery powered source or an external power source 70 or converter. The power source 70 mounts to the bottom 30. The support 80 is adapted to support the base 60 and provide clearance for the power source 70 to mount to the bottom 30. The support 80 is adapted to extend beyond the power source 70 such that the tray rests on the support 80. In alternate embodiments, the power source 70 may be mounted into a recess formed in the base 60 bottom 30. A switch means 130 is provided and operably connects to the power source 70 and lighting means 50. The switch means preferably operates to selectively provide power from the power source 70 to the lighting means 50 when the top 20 is in association with the container's 140 base 160. A single pole, single throw push-to-make or momentary switch would provide the described operation, although other switches may be used to provide different control features and operation.

In alternate embodiments, the lighting means 50 could comprise fiber optic strands operably connected to a light source. The fiber optic strands have a strand input for receiving light from the light source, and a strand output for emitting light. In such an embodiment, the cavity means 100 houses the fiber optic strand output. The fiber optic strand output disperses light up and through the base 60 and top 20. Strand outputs may also be arranged in an array with the cavity means comprising an array of cavities wherein each cavity receives an individual one of the fiber optic strand outputs.

While the preferred embodiment of the present invention has been described, additional variations and modifications in that embodiment may occur to those skilled in the art once they learn of the basic inventive concepts. Therefore, it is intended that the appended claims shall be construed to include both the preferred embodiment and all such variations and modifications as fall within the spirit and scope of the invention.

1. A tray for displaying containers comprising: a translucent base having an outer perimeter defining a top and a bottom, a cavity means disposed on the bottom and retaining a lighting means positioned to emit light through the base, and a power means operably connected to the lighting means.

2. A tray according to claim 1 wherein: the bottom further comprises a support dimensioned so as to extend beyond the power means, and the top has a flange extending upwardly from the outer perimeter.

3. A tray according to claim 1 wherein: the lighting means comprises at least one light-emitting diode operably connected to the power means.

4. A tray according to claim 1 wherein: the lighting means comprises an array of light emitting diodes, the cavity means is an array of cavities disposed on the bottom wherein each cavity is adapted to receive an individual one of the light emitting diodes.

5. A tray according to claim 4 wherein: the tray has a switch mounted on the top and operably connected to the power means and the plurality of light emitting diodes such that the switch is co-operably operable with containers placed on the tray to energize or de-energize the lighting means.

6. A tray according to claim 1 wherein: the lighting means comprises a light source for emitting light, a fiber optic element having an input for receiving light from the light source and an output for emitting light received from the light source, the cavity means adapted to receive the output.

7. A tray for displaying containers comprising:
a translucent base having an outer perimeter defining a top and a bottom, a cavity means disposed on the bottom adapted to receive a fiber optic element output, a light source for emitting light through the base, a fiber optic element comprising a plurality of fiber optic strands and each strand having a strand input for receiving light from the light source and a strand output for emitting light received from the light source, and the outputs in the aggregate form the fiber optic element output.

8. A tray and container system comprising: the tray further comprising a base having an outer perimeter defining a top and a bottom; at least one support means positioned on the bottom; a plurality of cavities formed in the base and a plurality of light emitting diodes, wherein each cavity is adapted to receive an individual one of the plurality of light emitting diodes; a power means mounted in a recess formed in the base bottom; a switch mounted on the top and operably connected to the power means and the plurality of light emitting diodes; a quadrilateral pyramidally disposed container having four triangular sides, a quadrilateral base in removable association with the top, and an apex; a flange disposed on the top and extending upwardly from the outer perimeter; the plurality of light emitting diodes positioned to direct light upwardly through the top and the container, wherein the power source provides power to the plurality of light emitting diodes when the container is in association with the top.
